(19) United States
(12) Patent Application Publication
(10) Pub. No.: US 2024/0404134 A1
(43) Pub. Date: Dec. 5, 2024

(54) METHOD, APPARATUS, DEVICE, READABLE STORAGE MEDIUM AND PRODUCT FOR MEDIA CONTENT PROCESSING

(71) Applicants: Beijing Zitiao Network Technology Co., Ltd., Beijing (CN); Lemon Inc., Grand Cayman (KY)

(72) Inventors: Jiaxin Ma, Beijing (CN); Dan Mao, Beijing (CN); Yixin Yang, Beijing (CN); Shuanglin Zhao, Beijing (CN)

(21) Appl. No.: 18/680,651

(22) Filed: May 31, 2024

(30) Foreign Application Priority Data
Jun. 2, 2023 (CN) 202310652620.2

(51) Int. Cl. G06T 11/20; G06T 7/12; G06V 10/44; G06V 10/46

(52) U.S. Cl. CPC G06T 11/203; G06T 7/12; G06V 10/44; G06V 10/46; G06V 2201/07

(57) ABSTRACT

Embodiments of the disclosure provide a method, apparatus, device, readable storage medium, and product for media content processing. The method includes: displaying video media content in a display interface, the video media content comprising at least one target video frame with a target object; in response to that the target video frame satisfies a preset drawing condition, generating a drawn image associated with the target object based on contour information of the target object in the target video frame; switching to display, in the display interface, a preset virtual brush and a drawing process of the drawn image by the virtual brush. In this way, processing manners of media content can be enriched, and display content in the display interface can be enriched, thereby improving user experience.

### CROSS-REFERENCE

This application claims priority to Chinese Patent Application No. 202310652620.2 entitled “METHOD, APPARATUS, DEVICE, READABLE STORAGE MEDIUM AND PRODUCT FOR MEDIA CONTENT PROCESSING” filed on Jun. 2, 2023, the entirety of which is incorporated herein by reference.

### FIELD

Embodiments of the present disclosure relate to the field of image processing technology, and in particular, to a media content processing method, apparatus, device, readable storage medium, and product for media content processing.

### BACKGROUND

A user may collect media content and perform an image processing operation on the media content on a terminal device. However, current media content processing methods generally display a processing result after processing the collected media content based on the content (such as filter, effects, etc.) selected by the user. The processing manner for media content is generally simple, resulting in poor user experience.

### SUMMARY

Embodiments of the present disclosure provide a media content processing method, apparatus, device, readable storage medium and product, so as to solve the technical problem that the processing manner of the current media content processing method is relatively simple.

According to a first aspect, an embodiment of the present disclosure provides a method for processing media content, including:
displaying video media content in a display interface, the video media content comprising at least one target video frame with a target object;
in response to that the target video frame satisfies a preset drawing condition, generating a drawn image associated with the target object based on contour information of the target object in the target video frame;
switching to display, in the display interface, a preset virtual brush and a drawing process of the drawn image by the virtual brush.

According to a second aspect, an embodiment of the present disclosure provides an apparatus for processing media content, including:
a display module configured to display video media content in a display interface, wherein the video media content comprising at least one target video frame with a target object;
a generating module configured to, in response to that the target video frame satisfies a preset drawing condition, generate a drawn image associated with the target object based on contour information of the target object in the target video frame; and
a processing module configured to switch to display a drawing process corresponding to the drawn image on the display interface.

According to a third aspect, an embodiment of the present disclosure provides an electronic device, including: a processor and a memory;
the memory stores computer execution instructions;
the processor executes the computer execution instructions stored in the memory, so that the processor implements a method for processing media content according to the first aspect and various possible designs of the first aspect.

According to a fourth aspect, an embodiment of the present disclosure provides a computer readable storage medium. The computer readable storage medium stores computer execution instructions. executing the computer execution instructions, a processor implements a method for processing media content according to the first aspect and various possible designs of the first aspect.

According to a fifth aspect, an embodiment of the present disclosure provides a computer program product, including a computer program. When being executed by a processor, the computer program implements a method for processing media content according to the first aspect and various possible designs of the first aspect.

### BRIEF DESCRIPTION OF THE DRAWINGS

In order to more clearly illustrate the technical solutions in the embodiments of the present disclosures or prior art, the following will be a brief introduction to the accompanying drawings required for the description of the embodiments or the prior art. Obviously, the accompanying drawings in the following description relate to some embodiments of the present disclosure. For those of ordinary skill in the art, other drawings can be obtained according to these drawings without creative labor.

FIG. 1 is a flowchart of a media content processing method provided by an embodiment of the present disclosure;

FIG. 2 is a schematic diagram of a display interface provided by an embodiment of the present disclosure;

FIG. 3 is a schematic flowchart of a media content processing method provided by another embodiment of the present disclosure;

FIG. 4 is a schematic flowchart of a media content processing method provided by another embodiment of the present disclosure;

FIG. 5 is a schematic diagram of a drawn image provided by an embodiment of the present disclosure;

FIG. 6 is a schematic flowchart of a media content processing method provided by another embodiment of the present disclosure;

FIG. 7 is a schematic structural diagram of a media content processing apparatus provided by an embodiment of the present disclosure;

FIG. 8 is a schematic structural diagram of an electronic device provided by an embodiment of the present disclosure.

### DETAILED DESCRIPTION

In order to make objects, technical solutions and advantages of the embodiments of the present disclosure more apparent, the technical solutions in the embodiments of the present disclosure will be described below clearly and completely in connection with the drawings in the embodiments of the present disclosure. Obviously, the described embodiments are only a part but not all of the embodiments of the present disclosure. Based on the embodiments of the present disclosure, all other embodiments obtained by those skilled in the art without creative efforts shall fall within the scope of protection of the present disclosure.

In order to solve the technical problem that the processing manner of the current media content processing method is relatively simple, the present disclosure provides a media content processing method, apparatus, device, readable storage medium and product.

It should be noted that, the media content processing method, apparatus, device, readable storage medium and product provided in the present disclosure may be applied in any application scenario for processing media content.

In the related art, after media content is obtained, a color parameter of the media content is generally adjusted, or an effect content is added to the media content, to realize processing on the media content, and then a processing result is directly displayed. However, the processing manner is usually relatively simple, and the content displayed in the display interface is also relatively simple, resulting in poor user experience.

In order to enrich the processing manner of the media content and enrich display effects in a display interface, after the video media content is displayed in the display interface, when it is detected that a video frame in the video media content satisfies a preset drawing condition, a drawn image associated with a target object may be generated based on contour information of the target object in the video frame. Further, a preset virtual brush may be displayed on the display interface, and a drawing process of a drawn image based on the virtual brush may be displayed.

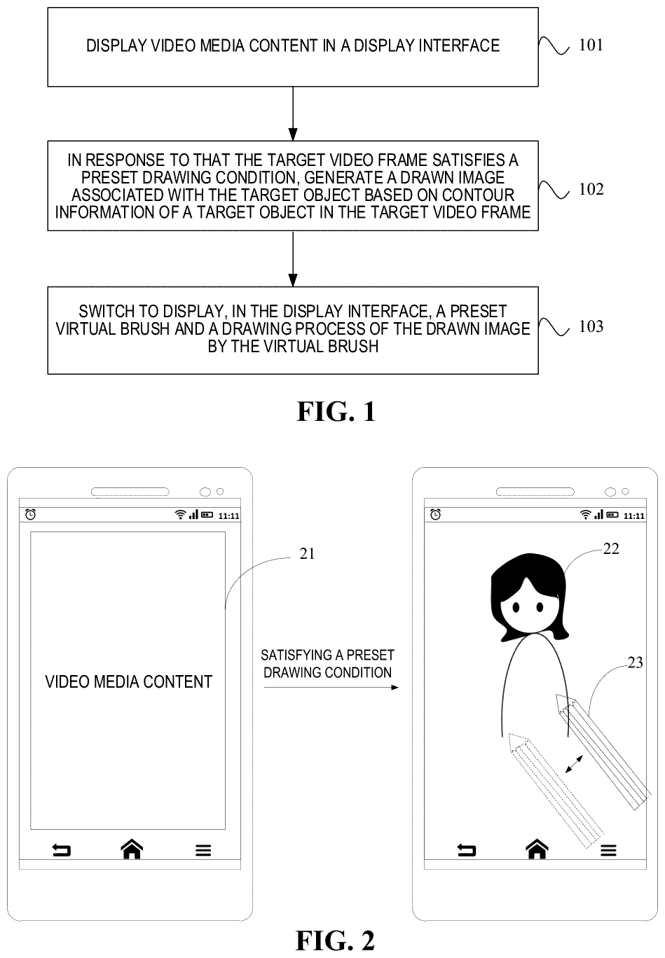

FIG. 1 is a schematic flowchart of a media content processing method provided by an embodiment of the present disclosure, and as shown in FIG. 1, the method includes:

Step 101: displaying video media content in a display interface, the video media content comprising at least one target video frame with a target object.

An execution subject of this embodiment is a media content processing apparatus. The media content processing apparatus may be coupled to a terminal device, so that media content processing can be implemented based on a trigger operation of a user on the terminal device. Optionally, the media content processing apparatus may also be coupled to a server, so that the server may obtain media content processing instructions transmitted by the terminal device based on the trigger operation of the user, and process media content based on the media content processing instructions. In addition, the server may control the terminal device to display the processed media content.

In the present embodiment, the video media content may be displayed in the display interface, where the video media content may be formed by a plurality of video frames. In the video media content, there may be at least one target video frame that has a target object therein. The target object may be a human body object, a human face object, an object, or the like, which is not limited in the present disclosure.

Optionally, the video media content may be collected by a preset image collecting apparatus in real time, or may be uploaded by the user according to actual requirements, which is not limited in the present disclosure.

At Step 102, in response to that the target video frame satisfies a preset drawing condition, generating a drawn image associated with the target object based on contour information of the target object in the target video frame.

In the present embodiment, in order to realize processing of the video media content, a drawing condition may be set in advance. After the video media content is displayed, it may be detected whether there is any target video frame in the video media content satisfying the preset drawing condition. The drawing condition includes, but is not limited to, a preset target key point existing in the target video frame, a target object in the target video frame makes a specific action, a target object in the target video frame makes a specific expression, and the like. The user may set a drawing condition according to actual requirements, which is not limited in the present disclosure.

Further, when it is detected that the target video frame satisfies the preset drawing condition, contour information of the target object in the target video frame can be recognized, and the drawn image associated with the target object is generated based on the contour information.

For example, the target object may be a human body image area. When it is detected that the target video frame satisfies the drawing condition, the human body may be traced based on the contour information of the human body image area by using a preset brush, so as to obtain the drawn image.

As an implementable manner, when the video media content is media content collected in real time, a recognition operation may be performed on the collected media content in real time, so as to determine whether the currently collected target video frame satisfies the drawing condition. If so, the drawn image associated with the target object is generated based on the contour information of the target object in the currently collected target video frame.

As an implementable manner, when the video media content is media content uploaded by the user, it may be sequentially detected, according to an order of the target video frames in the media content, whether each target video frame satisfies the drawing condition. If so, the drawn image associated with the target object is generated based on the contour information of the target object in the first target video frame that satisfies the drawing condition.

Step 103, switching to display, in the display interface, a preset virtual brush and a drawing process of the drawn image by the virtual brush.

In this embodiment, after obtaining the drawn image based on drawing the target object, the drawing process of the drawn image may be displayed on the display interface by switching.

Optionally, in order to improve authenticity of the drawing process, a preset virtual brush may be displayed in the display interface by switching, and the drawing process of the drawn image by the virtual brush may be displayed. For example, the virtual brush may be controlled to move, and during the movement, the drawing process of the drawn image may be presented.

As an implementable manner, the target media content may be generated based on the foregoing processing on the video media content, so that the user may perform a saving operation, a publishing operation, etc. on the target media content. For example, the target media content may include display of the video media content, a drawing process corresponding to the drawn image, and the like.

Optionally, on the basis of any one of the foregoing embodiments, before Step 101, the method further includes:
in response to a media content generation operation triggered by a user, collecting the video media content by the preset image collecting apparatus.
or,
in response to a media content generation operation triggered by a user, obtaining the video media content uploaded by the user in a preset storage path.

In this embodiment, the video media content may be collected by the preset image collecting apparatus in real time, or uploaded by the user according to actual requirements.

Optionally, the video media content may be collected by the preset image collecting apparatus in real time. Before the video media content is displayed, the video media content may be collected by the preset image collecting apparatus in response to a media content generation operation triggered by a user. Alternatively, the video media content may be uploaded by a user according to an actual requirement. Before the video media content is displayed, in response to a media content generation operation triggered by the user, the video media content uploaded by the user in a preset storage path is obtained.

Optionally, a preset media content generation control may be displayed on the display interface, and the user may generate the media content generation operation by a trigger operation on the media content generation control.

With the above proposed solutions, after video media content is displayed, the drawn image associated with the target object is generated based on contour information of the target object corresponding to the target video frame in the video media content, and a drawing process of the drawn image by the virtual brush is switched to display on the display interface. As such, the processing manner for media content can be enriched. Furthermore, display content in the display interface can be enriched, thereby improving user experience.

FIG. 2 is a schematic diagram of a display interface provided by an embodiment of the present disclosure. As shown in FIG. 2, a video media content 21 may be displayed in the display interface, and when a target object meets a preset drawing condition, a drawn image 22 associated with the target object is generated based on contour information of the target object in a target video frame associated with the video media content 21. A preset virtual brush 23 and a drawing process of the drawn image 22 by the virtual brush 23 is displayed in a display interface by switching.

According to the media content processing method provided in the embodiments, after the video media content is displayed, the drawn image associated with the target object is generated based on the contour information of the target object corresponding to the target video frame in the video media content, and the drawing process of the drawn image by means of the preset virtual brush is switched to be displayed, so that the processing of the media content can be enriched. Furthermore, the display content on the display interface can be enriched, thereby improving user experience.

Optionally, based on any one of the foregoing embodiments, Step 103 includes:
displaying, in a first display area of the display interface, the preset virtual brush and the drawing process of the drawn image by the virtual brush; and
displaying, in a second display area of the display interface, the target object in the video media content.

In this embodiment, in order to enrich the display content in the display interface, the target object in the video media content may also be displayed in the display interface.

Optionally, the display interface may comprise a first display area and a second display area, and the first display area and the second display area may be arranged in an up-down manner or in a left-right manner, or the second display area may be displayed in the first display area. The user may adjust the display sizes and the display positions of the first display area and the second display area according to actual requirements, which is not limited in the present disclosure.

After the drawn image is generated, the preset virtual brush and the drawing process of the drawn image by the virtual brush may be displayed in the first display area of the display interface. The target object in the video media content may be displayed in the second display area of the display interface.

By taking a practical application as an example, the preset virtual brush and the drawing process of the drawn image by the virtual brush may be displayed in full screen in the display interface, and the target object in the video media content may be displayed at the lower left corner of the display interface.

Optionally, the target object in the video media content may be intercepted, so as to implement the display operation on the target object.

According to the media content processing method provided by the embodiment, the drawing process of the drawn image and the target object are displayed on the display interface respectively, so that a real-time reaction of a user with respect to the drawing process can be displayed, thereby further enriching the display content in the display interface, and improving content quality of the target media content generated based on the drawing process and the target object.

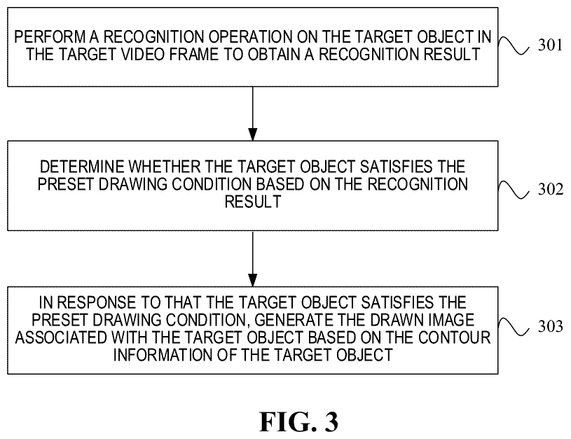

FIG. 3 is a schematic flowchart of a media content processing method according to another embodiment of the present disclosure. Based on any one of the foregoing embodiments, as shown in FIG. 3, Step 102 includes:

Step 301: performing a recognition operation on the target object in the target video frame to obtain a recognition result.

Step 302: determining, according to the recognition result, whether the target object satisfies the preset drawing condition.

Step 303: if the target object satisfies the preset drawing condition, generating the drawn image associated with the target object based on the contour information of the target object.

In this embodiment, in order to realize the processing of the video media content, the drawing condition may be set in advance. After displaying the video media content, a recognition operation may be performed on the target object in the target video frame to obtain a recognition result; whether the target object satisfies the preset drawing condition is determined according to the recognition result; and if so, a drawn image associated with the target object is generated based on contour information of the target object. Otherwise, if the drawing condition is not satisfied, the drawing operation will not be performed on the target object.

Optionally, for different drawing conditions, different recognition algorithms may be adopted to perform the recognition operation on the target object. For example, if the drawing condition is that the target video frame includes a preset human face key point, a preset human face recognition algorithm may be adopted to implement the recognition operation on the target object. If the drawing condition is that a preset target gesture exists in the target video frame, a preset gesture recognition algorithm may be used to implement the recognition operation on the target object. The present disclosure is not limited thereto.

Further, based on any one of the foregoing embodiments, Step 302 includes at least one of the following:
in response to determining, according to the recognition result, that the target object comprises a preset target key point, determining that the target object satisfies the preset drawing condition; or
in response to determining, according to the recognition result, that an expression feature of the target object matches a preset target expression and/or an action feature of the target object matches a preset target action, determining that the target object satisfies the preset drawing condition.

In this embodiment, the drawing condition may be that target video frame include a target key point, and the target key point include, but are not limited to, a human face key point, a human body key point, and the like. Based on the drawing condition, it may be determined, according to a recognition result, whether a preset target key point is included in the target object. If so, it is determined that the target object satisfies the preset drawing condition.

By taking a practical application as an example, whether the target video frame includes a human face key point may be recognized, and when it is detected that the target video frame includes the human face key point, the drawing operation is performed on the target object.

Optionally, the drawing condition may be that the target object in the target video frame makes a target expression and/or a target action. Based on the drawing condition, whether an expression feature matches with a preset target expression and/or an action feature of the target object matches with a preset target action may be determined according to the recognition result. If so, it is determined that the target object satisfies the preset drawing condition.

According to the media content processing method provided by the present embodiment, by presetting the drawing condition, when it is detected that a target key point exists in the target video frame, and/or when it is detected that the target object makes at least one of a target expression or a target action, the drawing operation is performed based on the contour information of the target object, so that interactive operations in the display interface can be enriched. Furthermore, display content and the processing manner for the media content can be enriched, thereby improving the user experience.

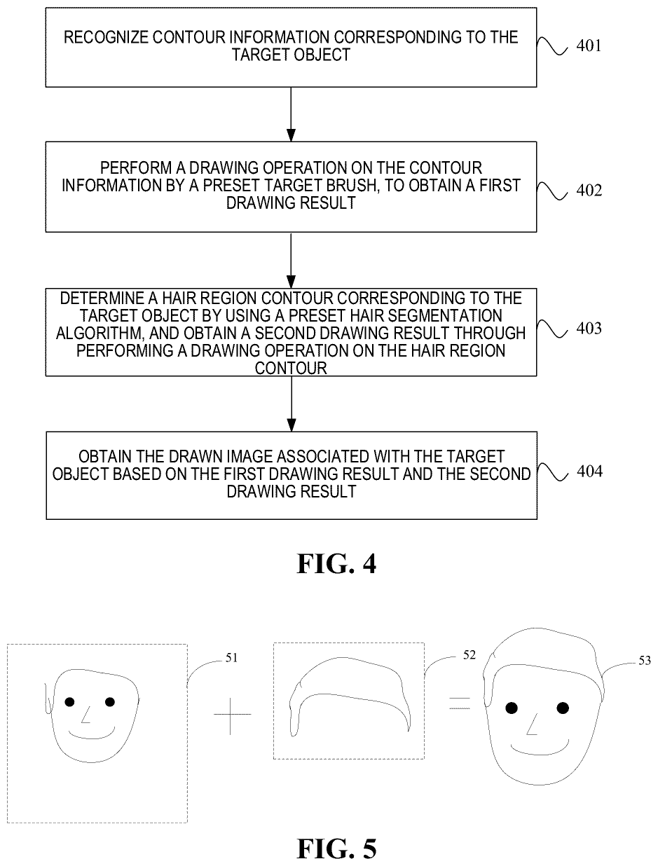

FIG. 4 is a schematic flowchart of a media content processing method according to another embodiment of the present disclosure. Based on any one of the foregoing embodiments, as shown in FIG. 4, Step 102 includes:

Step 401: recognizing contour information corresponding to the target object, wherein the contour information includes outer contour information and inner contour information;

Step 402, performing a drawing operation on the contour information by a preset target brush, to obtain a first drawing result;

Step 403: determining a hair region contour corresponding to the target object by using a preset hair segmentation algorithm, and obtaining a second drawing result based on the hair region contour; and

Step 404, obtaining the drawn image associated with the target object based on the first drawing result and the second drawing result.

In this embodiment, in order to implement the drawing operation on the target object, contour information corresponding to the target object may be first recognized, wherein the contour information includes outer contour information and inner contour information. For example, the contour information includes an external contour such as a face contour and a body contour, and may also include an internal contour such as a facial organ contour.

The first drawing result is obtained by performing the drawing operation on the contour information by the preset target brush, wherein the target brush may be selected by a user according to actual requirements, and the target brush may also be preset, which is not limited in the present disclosure. The target brush corresponds to parameters such as line thickness, line color and line type.

Further, since it is difficult to recognize hair edges, in order to obtain a clearer hair contour and hairlines, a hair region contour corresponding to the target object may be determined by means of a preset hair segmentation algorithm, and a second drawing result is obtained based on the hair region contour. The drawn image associated with the target object is obtained based on the first drawing result and the second drawing result. Optionally, the second drawing result may be superimposed on a hair region of the first drawing result to obtain the drawn image.

According to the media content processing method provided by the present embodiment, the first drawing result is obtained based on the contour information of the target object; the accurate hair region contour is determined by the preset hair segmentation algorithm, then the second drawing result is obtained based on the hair region contour; and then the drawn image associated with the target object is obtained based on the first drawing result and the second drawing result, so that a contour of the target object and a hair contour can be accurately drawn in the drawn image, thereby increasing the similarity between the drawn image and the target object.

Further, based on any one of the foregoing embodiments, Step 403 includes:
performing a segmentation operation on the target object by the preset hair segmentation algorithm, to obtain a target mask corresponding to a hair region; and
determining a second drawing result corresponding to the target object according to a preset channel value range and the target mask.

In this embodiment, a segmentation operation may be performed on the target object by using a preset hair segmentation algorithm, so as to obtain a target mask corresponding to a hair region. In the target mask, the R channel is a value of 0-1, 0 represents a non-hair region, and 1 represents a hair region. In order to obtain the second drawing result, the channel value range may be preset, and a portion matching the target mask is selected from the target mask based on the channel value range as the second drawing result.

As an implementable manner, the channel value range may be [0.2-0.37], or the channel value range may also be customized according to actual requirements. By adjusting the channel value range, the thickness of the stroke and the size of the hair contour may be controlled.

FIG. 5 is a schematic diagram of a drawn image provided by an embodiment of the present disclosure. As shown in FIG. 5, contour information corresponding to the target object can be recognized, and a first drawing result 51 is obtained by performing a drawing operation on the contour information through a preset target brush. Further, a hair region contour corresponding to the target object may be determined by using a preset hair segmentation algorithm, and the corresponding second drawing result 52 is determined based on the determined hair region contour. A drawn image 53 associated with the target object is obtained based on the first drawing result 51 and the second drawing result 52.

According to the media content processing method provided by the present embodiment, a segmentation operation is performed on the target object by means of the preset hair segmentation algorithm, so as to obtain the target mask corresponding to the hair region. The second drawing result corresponding to the target object is determined according to a preset channel value range and the target mask, so that a hair region contour can be accurately recognized. In addition, by adjusting the channel value range, the thickness of a stroke and the size of the hair contour can be controlled, thereby further increasing the similarity between the drawn image and the target object.

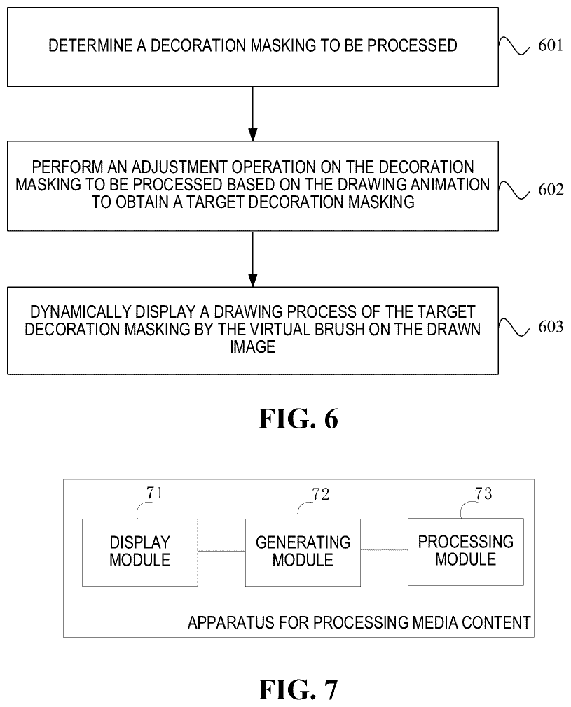

FIG. 6 is a schematic flowchart of a media content processing method provided by another embodiment of the present disclosure. Based on any one of the foregoing embodiments, as shown in FIG. 6, the method further includes: after Step 103,

Step 601, determining a decoration masking to be processed;

Step 602, performing an adjustment operation on the decoration masking to be processed based on the drawing animation to obtain a target decoration masking; and

Step 603, dynamically displaying a drawing process of the target decoration masking by the virtual brush on the drawn image.

In this embodiment, after the drawing operation on the drawn image is completed, effects such as beautification, uglification, and decoration may further be presented on the basis of the drawn image. The decoration operation may be automatically triggered after the drawing operation on the drawn image is completed, and may also be manually triggered by a user according to actual requirements, which is not limited in the present disclosure.

Optionally, a decoration masking to be processed may be determined, and the decoration masking to be processed may be selected by a user according to actual requirements, and may also be randomly determined in a plurality of preset decoration masks. The decoration masking includes a human face processing masking and/or a human body processing masking. The human face processing masking may realize decorative effects such as beautifying and uglifying a human face portion in a drawn image.

Further, the decoration masking to be processed may not match the size of the drawn image; therefore, in order to obtain a better display effect, an adjustment operation may be performed on the decoration masking to be processed based on a drawing animation, so as to obtain a target decoration masking. A drawing process of the target decoration masking by a virtual brush is dynamically displayed on the drawn image.

According to the media content processing method provided by this embodiment, a target decoration masking is determined after a drawing operation on the drawn image is completed, wherein the decoration masking includes a human face processing masking and/or a human body processing masking. The target decoration masking is drawn on the drawn image, so that the display content on the display interface can be further enriched, and the display effect is further optimized.

Further, based on any one of the foregoing embodiments, Step 601 includes:
in response to a decoration operation triggered by a user, displaying at least one preset decoration masking; and
in response to a selection operation of a user on the at least one decoration masking, determining a decoration masking selected by the user as the decoration masking to be processed.

In this embodiment, the decoration masking to be processed may be selected by a user according to actual requirements, and at least one preset decoration masking is displayed in response to a decoration operation triggered by the user. A decoration masking selected by the user is determined as the decoration masking to be processed in response to a selection operation of a user on the at least one decoration masking. The user may perform the selection operation on the at least one decoration masking by a trigger operation such as single clicking, double clicking and long pressing on the decoration masking.

According to the media content processing method provided by this embodiment, in response to the decoration operation triggered by the user, at least one preset decoration masking is displayed; in response to a selection operation of a user on the at least one decoration masking, the decoration masking selected by the user is determined as the decoration masking to be processed, so that the decoration masking to be processed that is finally used better conforms to the personalized requirements of the user, thereby improving the user experience.

Further, based on any one of the foregoing embodiments, Step 602 includes:
determining position information of at least one key point corresponding to the target object; and
performing a size scaling and/or shape adjustment operation on the decoration masking to be processed based on the position information of the at least one key point, to obtain the target decoration masking.

In this embodiment, in order to make the decoration to be processed better match the drawn image, position information of at least one key point corresponding to the target object may be determined. The key points include, but are not limited to, a human face key point and a human body key point. Based on the position information of the at least one key point, a size scaling and/or shape adjustment operation is performed on the decoration masking to be processed, so as to obtain the target decoration masking.

For example, if the size of the decoration to be processed is greater than the size of the drawn image, the decoration masking to be processed may be reduced based on the position information of the at least one key point. Alternatively, the shape adjustment operation, such as, distortion and deformation, may also be performed on the decoration masking to be processed, so that uglification or beatification effects on the drawn image can be obtained based on the adjusted target decoration masking.

According to the media content processing method provided by the present embodiment, a size scaling and/or shape adjustment operation is performed on the decoration masking to be processed based on the position information of at least one key point corresponding to the target object, so that the target decoration masking can better conform to the drawn image, thereby improving the matching degree between the drawn image and the target decoration mask.

Further, based on any one of the foregoing embodiments, Step 603 includes:
determining a display position of the target decoration masking on the drawn image according to the position information of the at least one key point; and
dynamically displaying, based on the display position, the drawing process of the target decoration masking by the virtual brush on the drawn image.

In this embodiment, in order to further improve the matching degree between the target decoration masking and the drawn image, the display position of the target decoration masking on the drawn image may be determined according to the position information of at least one key point. The drawing process of the target decoration masking by the virtual brush is dynamically displayed on a drawn image based on the display position. For example, a display position of a human face decoration masking on the drawn image may be determined based on position information of a human face key point, so that the human face decoration masking may accurately cover the human face.

Further, based on any one of the foregoing embodiments, the method further includes:
in response to a generation operation triggered by the user, generating target media content based on the drawing process corresponding to the drawn image and/or the drawing process of the target decoration masking.

In this embodiment, the target media content may be generated based on the foregoing processing on the video media content, so that the user performs a saving operation and a publishing operation on the target media content.

A preset generation control may be displayed on the display interface, and the user may trigger the generation operation by triggering the generation control. In response to a generation operation triggered by a user, the target media content is generated based on the drawing process corresponding to the drawn image and/or the drawing process of the target decoration mask.

According to the media content processing method provided by the present embodiment, the display position of the target decoration masking on the drawn image is determined based on the position information of at least one key point, so that the drawing operation of drawing the target decoration masking can be accurately realized based on the display position.

FIG. 7 is a schematic structural diagram of a media content processing apparatus according to an embodiment of the present disclosure. As shown in FIG. 7, the apparatus includes: a display module 71, a generating module 72, and a processing module 73. The display module 71 is configured to display video media content in a display interface, wherein the video media content comprising at least one target video frame with a target object. The generating module 72 is configured to generate a drawn image associated with the target object based on contour information of the target object in the target video frame, if the target video frame satisfies a preset drawing condition. The processing module 73 is configured to switch to display a drawing process corresponding to the drawn image on the display interface.

Further, on the basis of any of the above embodiments, the apparatus further includes: a collection module configured to collect the video media content through a preset image collecting apparatus in response to a media content generation operation triggered by a user; or an uploading module configured to obtain the video media content uploaded by the user in a preset storage path in response to a media content generation operation triggered by the user.

Further, on the basis of any one of the above embodiments, the generating module is configured to perform a recognition operation on the target object in the target video frame to obtain a recognition result; determine, according to the recognition result, whether the target object satisfies the preset drawing condition; and if the target object satisfies the preset drawing condition, generate the drawn image associated with the target object based on the contour information of the target object.

Further, on the basis of any one of the above embodiments, the generating module is configured to perform at least one of: in response to determining, according to the recognition result, that the target object comprises a preset target key point, determining that the target object satisfies the preset drawing condition; or in response to determining, according to the recognition result, that an expression feature of the target object matches a preset target expression and/or an action feature of the target object matches a preset target action, determining that the target object satisfies the preset drawing condition.

Further, on the basis of any one of the above embodiments, the generating module is configured to recognize contour information corresponding to the target object, wherein the contour information includes outer contour information and inner contour information; perform a drawing operation on the contour information by a preset target brush, to obtain a first drawing result; determine a hair region contour corresponding to the target object by using a preset hair segmentation algorithm, and obtain a second drawing result based on the hair region contour; and obtain the drawn image associated with the target object based on the first drawing result and the second drawing result.

Further, on the basis of any one of the above embodiments, the generating module is configured to perform a segmentation operation on the target object by the preset hair segmentation algorithm, to obtain a target mask corresponding to a hair region; and determine a second drawing result corresponding to the target object according to a preset channel value range and the target mask.

Further, on the basis of any one of the above embodiments, the processing module may be configured to display, in a first display area of the display interface, the preset virtual brush and the drawing process of the drawn image by the virtual brush; and display, in a second display area of the display interface, the target object in the video media content.

Further, on the basis of any one of the above embodiments, the apparatus further includes a determining module configured to determine a decoration masking to be processed; an adjusting module configured to perform an adjustment operation on the decoration masking to be processed based on the drawing animation to obtain a target decoration masking; and a display module configured to dynamically display a drawing process of the target decoration masking by the virtual brush on the drawn image.

Further, on the basis of any one of the above embodiments, the determining module is configured to display, in response to a decoration operation triggered by a user, at least one preset decoration masking; and determine, in response to a selection operation of a user on the at least one decoration masking, a decoration masking selected by the user as the decoration masking to be processed.

Further, on the basis of any one of the above embodiments, the adjusting module is configured to determine position information of at least one key point corresponding to the target object; and perform a size scaling and/or shape adjustment operation on the decoration masking to be processed based on the position information of the at least one key point, to obtain the target decoration masking.

Further, on the basis of any one of the above embodiments, the display module is configured to determine a display position of the target decoration masking on the drawn image according to the position information of the at least one key point; and dynamically display the drawing process of the target decoration masking by the virtual brush on the drawn image based on the display position.

Further, on the basis of any of the above embodiments, the decoration masking includes a human face processing masking and/or a human body processing masking.

Further, on the basis of any of the above embodiments, the apparatus further includes: a publishing module configured to generate, in response to a generation operation triggered by a user, target media content based on the drawing process corresponding to the drawn image and/or the drawing process of the target decoration masking.

The device provided in this embodiment may be used to execute the technical solutions of the foregoing method embodiments, and implementation principles and technical effects of the device are similar, which will not be repeatedly described herein in this embodiment.

In order to achieve the described embodiments, the embodiments of the present disclosure further provide an electronic device, including: a processor and a memory;

the memory stores computer execution instructions;

The processor executes the computer execution instructions stored in the memory, so that the processor implements the method for processing media content according to any one of the foregoing embodiments.

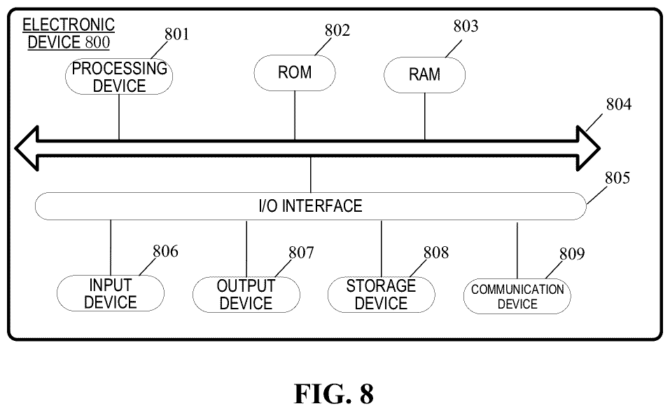

FIG. 8 is a schematic structural diagram of an electronic device according to an embodiment of the present disclosure. As shown in FIG. 8, the electronic device 800 may be a terminal device or a server. The terminal device may include, but is not limited to, a mobile terminal such as a mobile phone, a laptop computer, a digital broadcast receiver, a personal digital assistant (PDA for short), a tablet computer (PAD for short), a portable multimedia player (PMP for short), a vehicle-mounted terminal (for example, a vehicle-mounted navigation terminal), and the like, and a fixed terminal such as a digital TV, a desktop computer, and the like. The electronic device shown in FIG. 8 is merely an example and should not bring any limitation to the functions and scope of use of the embodiments of the present disclosure.

As shown in FIG. 8, the electronic device 800 may include a processing device (such as a central processing unit, graphics processing unit, etc.) 801, which may perform various appropriate actions and processes based on programs stored in Read-Only Memory (ROM for short) 802 or loaded from storage device 808 into Random Access Memory (RAM for short) 803. In the RAM 803, various programs and data necessary for the operation of the electronic device 800 are also stored. The processing device 801, ROM 802, and RAM 803 are connected to each other through a bus 804. An Input/Output I/O interface 805 is also connected to the bus 804.

Typically, the following devices can be connected to I/O interface 805: input devices 806 including, for example, touch screens, touchpads, keyboards, mice, cameras, microphones, accelerometers, gyroscopes, etc.; output devices 807 including liquid crystal displays (LCD for short), speakers, vibrators, etc.; storage devices 808 including magnetic tapes, hard disks, etc.; and a communication device 809. The communication device 809 may allow the electronic device 800 to communicate with other devices wirelessly or wirelessly to exchange data. Although FIG. 8 shows an electronic device 800 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 809, or installed from the storage device 808, or installed from the ROM 802. When the computer program is executed by the processing device 801, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

In order to implement the described embodiments, the embodiments of the present disclosure further provide a computer readable storage medium. The computer readable storage medium stores computer execution instructions, and when executing the computer execution instructions, the processor implements the media content processing method as described in any one of the described embodiments.

In order to implement the described embodiments, the embodiments of the present disclosure further provide a computer program product, including a computer program, wherein the computer program implements the method for processing media content as described in any one of the described embodiments when being executed by a processor.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device implements the method illustrated in the above embodiments.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

In a first aspect, according to one or more embodiments of the present disclosure, a method for processing media content is provided, including:
displaying video media content in a display interface, the video media content comprising at least one target video frame with a target object;
when the target video frame satisfies a preset drawing condition, generating a drawn image associated with the target object based on contour information of the target object in the target video frame; and
switching to display, in the display interface, a preset virtual brush and a drawing process of the drawn image by the virtual brush.

According to one or more embodiments of the present disclosure, the method further includes: before displaying the video media content in the display interfaces:
in response to a media content generation operation triggered by a user, collecting the video media content by a preset image collection apparatus;
or,
in response to a media content generation operation triggered by a user, obtaining the video media content uploaded by the user in a preset storage path.

According to one or more embodiments of the present disclosure, when the target video frame satisfies the preset drawing condition, generating the drawn image associated with the target object based on the contour information of the target object in the target video frame includes:
performing a recognition operation on the target object in the target video frame to obtain a recognition result;
determining, according to the recognition result, whether the target object satisfies the preset drawing condition; and
if the target object satisfies the preset drawing condition, generating the drawn image associated with the target object based on the contour information of the target object.

According to one or more embodiments of the present disclosure, determining, according to the recognition result, whether the target object satisfies the preset drawing condition comprises at least one of:
in response to determining, according to the recognition result, that the target object comprises a preset target key point, determining that the target object satisfies the preset drawing condition; or
in response to determining, according to the recognition result, that an expression feature of the target object matches a preset target expression and/or an action feature of the target object matches a preset target action, determining that the target object satisfies the preset drawing condition.

According to one or more embodiments of the present disclosure, generating the drawn image associated with the target object based on the contour information of the target object includes:
recognizing contour information corresponding to the target object, wherein the contour information comprises outer contour information and inner contour information;
performing a drawing operation on the contour information by a preset target brush, to obtain a first drawing result;
determining a hair region contour corresponding to the target object by using a preset hair segmentation algorithm, and obtaining a second drawing result based on the hair region contour; and
obtaining the drawn image associated with the target object based on the first drawing result and the second drawing result.

According to one or more embodiments of the present disclosure, determining the hair region contour corresponding to the target object by using the preset hair segmentation algorithm includes:
performing a segmentation operation on the target object by the preset hair segmentation algorithm, to obtain a target mask corresponding to a hair region; and
determining a second drawing result corresponding to the target object according to a preset channel value range and the target mask.

According to one or more embodiments of the present disclosure, switching to display, in the display interface, the preset virtual brush and the drawing process of the drawn image by the virtual brush includes:
displaying, in a first display area of the display interface, the preset virtual brush and the drawing process of the drawn image by the virtual brush; and
displaying, in a second display area of the display interface, the target object in the video media content.

According to one or more embodiments of the present disclosure, the method further includes: after switching to display, in the display interface, the preset virtual brush and a drawing process of the drawn image by the virtual brush,
determining a decoration masking to be processed;
performing an adjustment operation on the decoration masking to be processed based on the drawing animation to obtain a target decoration masking; and
dynamically displaying a drawing process of the target decoration masking by the virtual brush on the drawn image.

According to one or more embodiments of the present disclosure, determining the decoration masking to be processed includes:
in response to a decoration operation triggered by a user, displaying at least one preset decoration masking; and
in response to a selection operation of a user on the at least one decoration masking, determining a decoration masking selected by the user as the decoration masking to be processed.

According to one or more embodiments of the present disclosure, performing the adjustment operation on the decoration masking to be processed based on the drawing animation to obtain the target decoration masking comprises:
determining position information of at least one key point corresponding to the target object; and
performing a size scaling and/or shape adjustment operation on the decoration masking to be processed based on the position information of the at least one key point, to obtain the target decoration masking.

According to one or more embodiments of the present disclosure, dynamically displaying the drawing process of the target decoration masking by the virtual brush on the drawn image includes:
determining a display position of the target decoration masking on the drawn image according to the position information of the at least one key point; and
dynamically displaying the drawing process of the target decoration masking by the virtual brush on the drawn image based on the display position.

According to one or more embodiments of the present disclosure, the decoration masking includes a human face processing masking and/or a human body processing masking.

According to one or more embodiments of the present disclosure, the method further includes, in response to a generation operation triggered by a user, generating target media content based on the drawing process corresponding to the drawn image and/or the drawing process of the target decoration masking.

According to a second aspect, in one or more embodiments of the present disclosure, an apparatus for processing media content is provided, including:
a display module configured to display video media content in a display interface, wherein the video media content comprising at least one target video frame with a target object;
a generating module configured to, in response to that the target video frame satisfies a preset drawing condition, generate a drawn image associated with the target object based on contour information of the target object in the target video frame; and
a processing module configured to switch to display a drawing process corresponding to the drawn image on the display interface.

According to one or more embodiments of the present disclosure, the apparatus further includes:
a collection module configured to collect the video media content by a preset image collection apparatus in response to a media content generation operation triggered by a user;
or,
an uploading module configured to obtain the video media content uploaded by the user in a preset storage path in response to a media content generation operation triggered by the user.

According to one or more embodiments of the present disclosure, the generating module is configured to:
perform a recognition operation on the target object in the target video frame to obtain a recognition result;
determine, according to the recognition result, whether the target object satisfies the preset drawing condition; and
if the target object satisfies the preset drawing condition, generate the drawn image associated with the target object based on the contour information of the target object.

According to one or more embodiments of the present disclosure, the generating module is configured to perform at least one of:
in response to determining, according to the recognition result, that the target object comprises a preset target key point, determining that the target object satisfies the preset drawing condition; or
in response to determining, according to the recognition result, that an expression feature of the target object matches a preset target expression and/or an action feature of the target object matches a preset target action, determining that the target object satisfies the preset drawing condition.

According to one or more embodiments of the present disclosure, the generating module is configured to:
recognize contour information corresponding to the target object, wherein the contour information comprises outer contour information and inner contour information;
perform a drawing operation on the contour information by a preset target brush, to obtain a first drawing result;
determine a hair region contour corresponding to the target object by using a preset hair segmentation algorithm, and obtaining a second drawing result based on the hair region contour; and
obtain the drawn image associated with the target object based on the first drawing result and the second drawing result.

According to one or more embodiments of the present disclosure, the generating module is configured to:
perform a segmentation operation on the target object by the preset hair segmentation algorithm, to obtain a target mask corresponding to a hair region; and
determine a second drawing result corresponding to the target object according to a preset channel value range and the target mask.

According to one or more embodiments of the present disclosure, the processing module is configured to:
display, in a first display area of the display interface, the preset virtual brush and the drawing process of the drawn image by the virtual brush; and
display, in a second display area of the display interface, the target object in the video media content.

According to one or more embodiments of the present disclosure, the apparatus further includes:
a determining module configured to determine a decoration masking to be processed;
an adjusting module configured to perform an adjustment operation on the decoration masking to be processed based on the drawing animation to obtain a target decoration masking; and
a display module configured to dynamically display a drawing process of the target decoration masking by the virtual brush on the drawn image.

According to one or more embodiments of the present disclosure, the determining module is configured to:

display, in response to a decoration operation triggered by a user, at least one preset decoration masking; and

determine, in response to a selection operation of a user on the at least one decoration masking, a decoration masking selected by the user as the decoration masking to be processed.

According to one or more embodiments of the present disclosure, the adjusting module is configured to:
determine position information of at least one key point corresponding to the target object; and
perform a size scaling and/or shape adjustment operation on the decoration masking to be processed based on the position information of the at least one key point, to obtain the target decoration masking.

According to one or more embodiments of the present disclosure, the display module is configured to:
determine a display position of the target decoration masking on the drawn image according to the position information of the at least one key point; and
dynamically display the drawing process of the target decoration masking by the virtual brush on the drawn image based on the display position.

According to one or more embodiments of the present disclosure, the decoration masking includes a human face processing masking and/or a human body processing masking.

According to one or more embodiments of the present disclosure, the apparatus further includes:

a publishing module configured to, in response to a generation operation triggered by a user, generate target media content based on the drawing process corresponding to the drawn image and/or the drawing process of the target decoration masking.

In a third aspect, according to one or more embodiments of the present disclosure, there is provided an electronic device, including: at least one processor and a memory;
the memory stores computer execution instructions; and

The at least one processor executes computer execution instructions stored in the memory, so that the at least one processor implements method for processing media content according to the first aspect and various possible designs of the first aspect.

In a fourth aspect, according to one or more embodiments of the present disclosure, there is provided a computer readable storage medium. The computer readable storage medium stores computer execution instructions. When executing the computer execution instructions, a processor implements a method for processing media content according to the first aspect and various possible designs of the first aspect is implemented.

In a fifth aspect, according to one or more embodiments of the present disclosure, there is provided a computer program product, including a computer program, where when being is executed by a processor, the computer program implements a method for processing media content according to the foregoing first aspect and various possible designs of the first aspect.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1. A method for processing media content, comprising:
displaying video media content in a display interface, the video media content comprising at least one target video frame with a target object;
in response to that the target video frame satisfies a preset drawing condition, generating a drawn image associated with the target object based on contour information of the target object in the target video frame; and
switching to display, in the display interface, a preset virtual brush and a drawing process of the drawn image by the virtual brush.

2. The method of claim 1, wherein in response to that the target video frame satisfies the preset drawing condition, generating the drawn image associated with the target object based on the contour information of the target object in the target video frame comprises:
performing a recognition operation on the target object in the target video frame to obtain a recognition result;
determining whether the target object satisfies the preset drawing condition based on the recognition result; and
in response to that the target object satisfies the preset drawing condition, generating the drawn image associated with the target object based on the contour information of the target object.

3. The method of claim 2, wherein determining whether the target object satisfies the preset drawing condition based on the recognition result comprises at least one of:
in response to determining, according to the recognition result, that the target object comprises a preset target key point, determining that the target object satisfies the preset drawing condition; or
in response to determining, according to the recognition result, that an expression feature of the target object matches a preset target expression and/or an action feature of the target object matches a preset target action, determining that the target object satisfies the preset drawing condition.

4. The method of claim 1, wherein generating the drawn image associated with the target object based on the contour information of the target object comprises:
recognizing contour information corresponding to the target object, wherein the contour information comprises outer contour information and inner contour information;
performing a drawing operation on the contour information by a preset target brush, to obtain a first drawing result;
determining a hair region contour corresponding to the target object by using a preset hair segmentation algorithm, and obtaining a second drawing result based on the hair region contour; and
obtaining the drawn image associated with the target object based on the first drawing result and the second drawing result.

5. The method of claim 4, wherein determining the hair region contour corresponding to the target object by using the preset hair segmentation algorithm comprises:
performing a segmentation operation on the target object by the preset hair segmentation algorithm, to obtain a target mask corresponding to the hair region; and
determining the second drawing result corresponding to the target object according to a preset channel value range and the target mask.

6. The method of claim 1, wherein switching to display, in the display interface, the preset virtual brush and the drawing process of the drawn image by the virtual brush comprises:
displaying, in a first display area of the display interface, the preset virtual brush and the drawing process of the drawn image by the virtual brush; and
displaying, in a second display area of the display interface, the target object in the video media content.

7. The method of claim 1, wherein the method further comprises: after switching to display, in the display interface, the preset virtual brush and the drawing process of the drawn image by the virtual brush,
determining a decoration masking to be processed;
performing an adjustment operation on the decoration masking to be processed based on the drawing animation to obtain a target decoration masking; and
dynamically displaying, on the drawn image, a drawing process of the target decoration masking by the virtual brush.

8. The method of claim 7, wherein determining the decoration masking to be processed comprises:
in response to a decoration operation triggered by a user, displaying at least one preset decoration masking; and
in response to a selection operation of a user on the at least one decoration masking, determining a decoration masking selected by the user as the decoration masking to be processed.

9. The method of claim 7, wherein performing the adjustment operation on the decoration masking to be processed based on the drawing animation to obtain the target decoration masking comprises:
determining position information of at least one key point corresponding to the target object; and
performing a size scaling operation and/or a shape adjustment operation on the decoration masking to be processed based on the position information of the at least one key point, to obtain the target decoration masking.

10. The method of claim 9, wherein dynamically displaying on the drawn image the drawing process of the target decoration masking by the virtual brush comprises:
determining a display position of the target decoration masking on the drawn image according to the position information of the at least one key point; and
dynamically displaying the drawing process of the target decoration masking by the virtual brush on the drawn image based on the display position.

11. The method of claim 7, wherein the decoration masking comprises a human face processing masking and/or a human body processing masking.

12. The method of claim 7, further comprising:
in response to a generation operation triggered by a user, generating target media content based on the drawing process corresponding to the drawn image and/or the drawing process of the target decoration masking.

13. An electronic device, comprising: a processor and a memory;
the memory storing computer execution instructions; and
the processor executing the computer execution instructions stored in the memory, to cause the processor to perform acts comprising:
displaying video media content in a display interface, the video media content comprising at least one target video frame with a target object;
in response to that the target video frame satisfies a preset drawing condition, generating a drawn image associated with the target object based on contour information of the target object in the target video frame; and
switching to display, in the display interface, a preset virtual brush and a drawing process of the drawn image by the virtual brush.

14. The device of claim 13, wherein in response to that the target video frame satisfies the preset drawing condition, generating the drawn image associated with the target object based on the contour information of the target object in the target video frame comprises:
performing a recognition operation on the target object in the target video frame to obtain a recognition result;
determining whether the target object satisfies the preset drawing condition based on the recognition result; and
in response to that the target object satisfies the preset drawing condition, generating the drawn image associated with the target object based on the contour information of the target object.

15. The device of claim 14, wherein determining whether the target object satisfies the preset drawing condition based on the recognition result comprises at least one of:
in response to determining, according to the recognition result, that the target object comprises a preset target key point, determining that the target object satisfies the preset drawing condition; or
in response to determining, according to the recognition result, that an expression feature of the target object matches a preset target expression and/or an action feature of the target object matches a preset target action, determining that the target object satisfies the preset drawing condition.

16. The device of claim 13, wherein generating the drawn image associated with the target object based on the contour information of the target object comprises:
recognizing contour information corresponding to the target object, wherein the contour information comprises outer contour information and inner contour information;
performing a drawing operation on the contour information by a preset target brush, to obtain a first drawing result;
determining a hair region contour corresponding to the target object by using a preset hair segmentation algorithm, and obtaining a second drawing result based on the hair region contour; and
obtaining the drawn image associated with the target object based on the first drawing result and the second drawing result.

17. The device of claim 16, wherein determining the hair region contour corresponding to the target object by using the preset hair segmentation algorithm comprises:
performing a segmentation operation on the target object by the preset hair segmentation algorithm, to obtain a target mask corresponding to the hair region; and
determining the second drawing result corresponding to the target object according to a preset channel value range and the target mask.

18. The device of claim 13, wherein switching to display, in the display interface, the preset virtual brush and the drawing process of the drawn image by the virtual brush comprises:
displaying, in a first display area of the display interface, the preset virtual brush and the drawing process of the drawn image by the virtual brush; and
displaying, in a second display area of the display interface, the target object in the video media content.

19. The device of claim 13, wherein the processor is further caused to perform acts comprising: after switching to display, in the display interface, the preset virtual brush and the drawing process of the drawn image by the virtual brush,
determining a decoration masking to be processed;
performing an adjustment operation on the decoration masking to be processed based on the drawing animation to obtain a target decoration masking; and
dynamically displaying, on the drawn image, a drawing process of the target decoration masking by the virtual brush.

20. A non-transitory computer readable storage medium storing computer execution instructions, the computer execution instructions, when executed by a processor, implementing acts comprising:
displaying video media content in a display interface, the video media content comprising at least one target video frame with a target object;
in response to that the target video frame satisfies a preset drawing condition, generating a drawn image associated with the target object based on contour information of the target object in the target video frame; and
switching to display, in the display interface, a preset virtual brush and a drawing process of the drawn image by the virtual brush.
